(19) United States
(12) Patent Application Publication
(10) Pub. No.: US 2006/0253282 A1
(43) Pub. Date: Nov. 9, 2006

(54) System for automatic recognition of vehicle operating noises

(76) Inventors: Gerhard Uwe Schmidt, Ulm (DE); Markus Buck, Biberach (DE); Tim Haulick, Blaubeuren (DE)

Correspondence Address: BRINKS HOFER GILSON & LIONE, P.O. BOX 10395, CHICAGO, IL, 60610, US

(21) Appl. No.: 11/376,001

(22) Filed: Mar. 14, 2006

(30) Foreign Application Priority Data
Mar. 14, 2005 (EP) 05005509.4

(51) Int. Cl. G10L 15/20

(52) U.S. Cl. 704/233

(57) ABSTRACT

A system automatically recognizes a vehicle operating condition through a microphone positioned within the vehicle. The microphone detects acoustic signals. A database stores speech templates and operating noise templates. A feature extracting module receives microphone signals and extracts a set of operating noise feature parameters or speech feature parameters from the microphone signals. A speech and noise recognition module may determine an operating noise template that best matches a set of extracted operating noise feature parameters and/or a speech template. The speech template best matches the set of extracted speech feature parameters.

### PRIORITY CLAIM

This application claims the benefit of priority from European Patent Application No. 05005509.4, filed Mar. 14, 2005, which is incorporated by reference.

### BACKGROUND OF THE INVENTION

1. Technical field.

The present invention relates to vehicle diagnostics. In particular, the invention relates to the automatic recognition of vehicle operating noises by means of microphones. The recognized noises may be used to detect present or future operating faults.

2. Related Art.

Diagnosing the operating status of a vehicle is an important part of maintaining and repairing a vehicle. Effective diagnostic tests may detect undesirable operating conditions and anticipate mechanical failures, thereby improving the performance and safety of the vehicle. In recent years, automobiles have been equipped with diagnostic sensors and processing equipment designed to monitor the operation of the vehicle and record faults and other operating parameters. Such information may be helpful to a mechanic servicing a vehicle. Today many service facilities include computers, data recorders, oscilloscopes and other electronic equipment for measuring and monitoring signals generated by electronic sensors and other electrical components commonly mounted on vehicles.

Remote vehicle diagnostics allow data sampled by on board vehicle sensors to be wirelessly transmitted to external databases such as an external database located at a service station. Immediate support may be made available in cases when problems are detected. Remote diagnostic centers may alert drivers to unsafe operating conditions that may lead to significant or catastrophic failures. Such alerts may be accompanied by instructions to the driver of the vehicle, telling the driver what steps may be taken to mitigate damage and/or protect the safety of passengers.

Acoustic signals represent an important source of information regarding the operational state of a vehicle. In particular, acoustic signals may provide important information about the state of the engine, drive train, wheel bearings and other operatively connected components. In many cases automotive mechanics may diagnose problems or determine the source of failures just from listening to the sound of an engine, or driving a vehicle and listening for other sonic abnormalities. However, in many cases, the owner or frequent driver of a vehicle will not be sufficiently skilled to analyze acoustic information produced during day-to-day operation to detect and analyze problems. Furthermore, the human ear is limited to detecting sounds in a relatively narrow frequency band. Often valuable acoustic information about the operational state of a vehicle will be contained in frequency ranges outside the detectable range of the human ear. Moreover, many malfunctions develop slowly. Changes in the acoustic signals associated with slowly evolving malfunctions may go undetected by the person or persons using a vehicle. For these reasons electronic acoustical sensors are a preferred mechanism for acquiring and analyzing acoustic signals associated with the operation of a vehicle.

Many present generation vehicle diagnostic systems that include an acoustic analysis component rely of audio sensors mounted outside the vehicle cabin, near the source of the sounds being analyzed. Sensors mounted outside the vehicle cabin are less protected and are more subject to aging and corrosion due to exposure to the elements and environmental contaminates such as road salt and the like.

A more reliable and durable audio diagnostic system is desired. Such a system should include acoustic sensors located in a protected environment, such as the inside of the vehicle cabin. Further, an improved audio diagnostic system may be inexpensive and should not require large numbers of sensors.

### SUMMARY

A system for automatic recognition of vehicular noises includes a microphone installed within a cabin of a vehicle. The microphone is adapted to detect acoustic signals within the cabin and generate corresponding microphone signals. A database stores both speech templates and vehicle operating noises. A feature extracting module is configured to receive the microphone signals and to extract at least one of a set of operating noise feature parameters and at least one set of speech feature parameters from the microphone signals. The extracted noise feature parameters and the extracted speech feature parameters are analyzed by a speech and noise recognition module. The speech and noise recognition module is configured to identify an operating noise template stored in the database that includes operating noise feature parameters that provide the best match with the set of operating noise feature parameters extracted from the microphone signals by the feature extracting module, or a speech template stored in the database that includes speech feature parameters that provide the best match with the set of speech feature parameters extracted from the microphone signals by the feature extracting module.

The system further encompasses a method for recognizing vehicle operating noise. The method includes providing a speech recognition system that includes a database for storing speech templates and operating noise templates. Microphone signals are generated from acoustic signals within the vehicle by microphones mounted on the vehicle. At least one of a set of operating noise feature parameters and a set of speech feature parameters are extracted from the microphone signals. And finally, determining an operating noise template that best matches the set of extracted operating noise feature parameters or determining a speech template that best matches the set of extracted speech feature parameters, depending on whether operating noise feature parameters or speech feature parameters have been extracted from the microphone signals.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an operating noise and speech recognition system.

FIG. 2 is a block diagram of an operating noise and speech recognition system.

FIG. 3 is a flowchart of a method of recognizing operating noise and speech.

FIG. 4 is a flowchart of a method of recognizing operating noise and speech.

### DETAILED DESCRIPTION OF THE PREFERRED EMBODIMENTS

A vehicle diagnostic system analyzes acoustic signals to determine characteristics of the operational status of the vehicle. The vehicle diagnostic system may be a dedicated system, or may be combined with a speech recognition system. An acoustic vehicle diagnostic system may be fashioned from a modified speech recognition system. Well known tools from speech recognition systems may be adapted to classify noise signals and identify acoustic patterns that may indicate impending faults or other operating anomalies. The result is an effective, reliable system for monitoring the operation of the vehicle and detecting and analyzing problems when they occur.

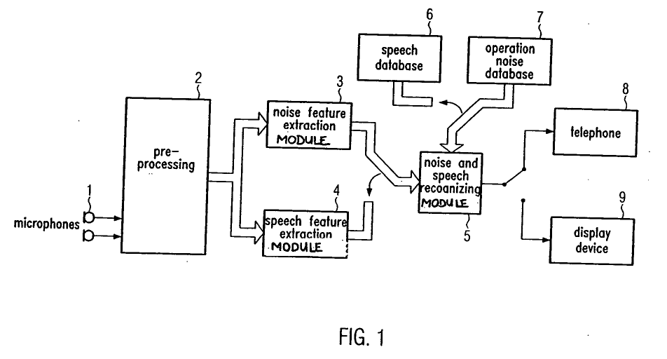

FIG. 1 is a block diagram of an acoustic vehicle diagnostic system. The vehicle diagnostic system includes one or more microphones 1, a pre-processor 2, a noise feature extraction module 3, a speech feature extraction module 4, and a noise and speech recognition module 5. The system further includes a speech database 6 and an operating noise database 7. System output devices may include a telephone 8, a display device 9, or some other output device.

One or more microphones 1 installed in the vehicle cabin are arranged to detect acoustic signals that may include both passenger speech and vehicle operating noises. The one or more microphones 1 may include a single microphone, an array of microphones, or multiple arrays of microphones. A microphone array may comprise at least one first microphone configured for use in a speech recognition system and/or a speech dialog system and/or vehicle hands-free set, and/or at least one second microphone capable of detecting acoustic signals in frequencies below and/or above the frequency range detected by the first microphone.

If microphones from an existing speech dialog system or speech recognition system are the only microphones used, almost no hardware modifications to existing speech recognition or speech dialog systems are needed to install the vehicle operating noise recognition system in vehicles equipped with such speech processing systems.

Using existing microphones for detecting speech signals has cost advantages. It is also useful to install additional microphones that are able to detect, for example, frequency ranges that are below and/or above the frequencies that are detected by microphones designed to capture verbal utterances. Employing microphones specially designed for frequency ranges above and, in particular, below the frequency range of some microphones installed in vehicular cabins may significantly improve the noise recognition abilities of the present system.

Furthermore, a microphone array may be used that includes at least one directional microphone or a microphone array having multiple directional microphones pointing in different directions. Multiple directional microphones improve the reliability of the vehicle noise recognition process and may also provide a better localization of operating faults if and when such faults are detected. For example, if a wheel bearing fault is detected, directional microphones may be helpful in determining which of the typical four wheel bearings is failing.

Acoustic signals within the vehicle cabin are detected by the one or more microphones 1 and transformed into electrical signals. The microphone signals are pre-processed by the pre-processor 2. In particular, the microphone signals are digitized and quantized by the pre-processor 2. The pre-processor may also perform a Fast Fourier Transformation (FFT) or some other similar transformation to convert the digitized microphone signals from the time domain into the frequency domain. The pre-processor 2 may also apply appropriate time delays in order to synchronize the microphone signals received from different microphones. The pre-processor 2 may also employ an adaptive beam former in order to emphasize sounds originating from a particular direction, such as from the engine compartment, the drive train, transmission, from the driver or passenger, or from some other source. The beamformer may be implemented not only to enhance the intelligibility of speech but also to improve the quality of noise signals in order to improve the reliability of the identification of vehicle operating noises.

One may also use an inversely operating beamformer. An inversely operating beamformer synchronizes the microphone signals and outputs beamformed signals with an enhance signal-to-noise level for improved vehicle noise recognition. Spatial nulls can be created (fixedly or adaptively) in the direction of the passengers in order to suppress speech signals while maintaining vehicle noise components of the microphone signals.

The noise feature extraction module 3 and the speech feature extraction module 4 perform similar functions and need not be physically separate entities. The noise extraction module 3 and the speech feature extraction module 4 may obtain feature vectors corresponding to the acoustic signals detected by the microphones 1. Feature vectors comprise feature parameters that characterize the detected audio signals. For example, a feature vector obtained by the noise feature extraction module 3 will include feature parameters characterizing vehicle operating noises. A feature vector obtained by the speech extraction module 4 will include feature parameters characterizing human speech. Such vectors may comprise about 10 to about 20 feature parameters and may be calculated about every 10 or 20 msec, from, for example, short-term power spectra for multiple subbands of the received microphone signals. The feature vectors obtained from the noise feature extraction module 3 and the speech feature extraction module 4 are suitable for use in the subsequent recognition processes described below.

The noise and speech recognition module 5 performs a sound recognition process based on the noise and speech feature vectors obtained by the noise feature extraction module 3 and the speech feature extraction module 4. The noise and speech recognition module 5 employs the speech database 6 and the operating noise database 7 to recognize the various sounds detected by the one or more microphones 1. The speech database 6 stores speech templates and the operating noise database 7 stores vehicle operating noise templates. The speech and operating noise templates comprise feature vectors that have been assigned to data representations of verbal utterances and vehicle operating noises, respectively.

Recognition of operation noises comprises classifying and/or identifying these noises. Classes of operation noises may comprise, for example, wheel bearing noise, ignition noise, braking noise, speed dependent engine noise, and so forth. Each class may comprise sub-classes for noise samples representing, for example, regular, critical and supercritical operating conditions. Both the noise and the speech templates represent trained/learned models of particular acoustic signals. The templates may include feature (characteristic) vectors for the particular acoustic signals including the most relevant feature parameters such as the cepstral coefficients or amplitudes for each frequency bin. Training the templates is preferably carried out in collaboration with a skilled mechanic. The training involves detecting and recording vehicle operating noises that reflect the vehicle operating under normal circumstances and under various fault conditions. Preferably templates are created for and trained on specific vehicle models. Such individualized training is relatively time-consuming, but enhances the reliability of the noise recognition.

If the acoustic signals detected by the microphones 1 and pre-processed by the pre-processor 2 include speech, the associated feature vector or feature vectors are compared with the speech feature vectors stored as speech templates in the speech database 6. Some feature parameters for speech signals are, e.g., amplitudes, cepstral coefficients, predictor coefficients and the like. The noise and speech recognizing module 5 determines the best matching template or templates for the speech signals detected within the acoustic signals picked up by the microphones 1 and the corresponding data representations of verbal utterances are identified. Once the corresponding verbal utterances have been identified the system may be made to respond in an appropriate manner. For example, depending on the verbal utterances that have been identified, an application such as the telephone 8 may be accessed and used. Alternatively, an audio device such as a car radio or some other device may be controlled via verbal commands, and so forth. Speech recognition employing, for example. Hidden Markov Models may be used.

If the acoustic signals detected by the microphones 1 and pre-processed by the pre-processing module 2 include operating noise signals, the associated noise feature vector or noise feature vectors are compared with the operating noise feature vectors stored as operating noise templates in the operating noise database 7. Noise signals within the acoustic signals are recorded as the microphones are assigned to one or more best matching noise templates of a database. Specifically, the feature vectors comprising feature parameters and generated by the feature extraction means may be compared with feature vectors representing said operation noise templates. These noise templates may comprise previously generated templates and also templates calculated, e.g., by some averaging, from previously generated noise templates. Generation of the noise templates may be performed by detecting noise caused by the regular operation and different kinds of faulty operation of vehicle components. Noise templates that represent noise associated with some technical failures may be considered as elements of a particular set of fault-indicating templates. Noise feature parameters may include some of the speech feature parameters or appropriate modifications thereof as highly resolved bandpass power levels in the low-frequency range.

The noise and speech recognizing module 5 determines the best matching template or templates for the operating noises selected within the acoustic signals picked up by the microphones 1, and the corresponding data representations of operating noises are identified. Specifically, the feature vectors comprising feature parameters and generated by the feature extraction means may be compared with feature vectors representing the operating noise templates. These noise templates may comprise previously generated templates and also templates calculated, for example, by some averaging, from previously generated noise templates.

Depending on the identified noise template, the display device 9 may be made to display appropriate diagnostic information. For example, for each operating noise template, or for particular classes of operating noise templates, specific information can be displayed on the display device 9.

Preferably, the system for automatic recognition of vehicle operating noises may further include at least one application configured to operate on the basis of at least one determined best matching speech template or at least one determined best matching vehicle operating noise template.

For example, the system may be adapted to operate a mobile phone. If a speech template representing a phone number is identified, the particular phone number may be dialed by the mobile phone. Another application may be an output display. Information corresponding to an identified vehicle operating noise template may be shown on the display.

Alternatively, an application includes a warning device configured to output an acoustic and/or visual and/or haptic warning. The speech and noise recognition system may be configured to activate the warning device when the system determines that the difference between an extracted noise feature parameter and a noise feature parameters of the operation noise template determined to be the best match the at least one set of extracted noise feature parameters exceeds a predetermined level, or if the vehicle operating noise template determined to best match the at least one set of extracted noise feature parameters is an element of a predetermined set of vehicle operating noise templates indicative of one or more particular for operating faults. Thus, a driver of the vehicle may be warned if a failure affecting the operation of the vehicle is to be expected in the near future. With advance warning, the driver can react accordingly to avoid severe damage and risk.

The at least one application means may comprise a wireless communication device configured to transmit the best matching operation noise template and/or the at least one extracted set of noise feature parameters and/or the generated microphone signals to a remote location such as a vehicle service center, for remote analysis. Such a wireless communication device may comprise a mobile phone. On the basis of the received data mechanics may be informed about the operation status and safety of the vehicle and may communicate a warning or provide assistance to the driver in case of severe failures or emergencies by telecommunication. The wireless communication device may be configured to automatically transmit data comprising the best matching vehicle operating noise template and/or the at least one set of extracted noise feature parameters and/or the generated microphone signals, if the difference between the extracted noise feature parameters and the noise feature parameters of the vehicle operating noise template determined to best match the at least one set of extracted noise feature parameters exceeds a predetermined level and/or if the operation noise template determined to best match the at least one set of extracted noise feature parameters is an element of a predetermined set of particular operation noise templates indicative of vehicle operating faults.

Alternatively, the application may include a speech output device configured to output an audio or verbal warning. The audio or verbal warning may be generated if the difference between the extracted noise feature parameters and the noise feature parameters of the operation noise template determined to best match the at least one set of extracted noise feature parameters exceeds a predetermined level and/or if the operating noise template determined to best match the at least one set of extracted noise feature parameters is an element of a predetermined set of particular vehicle operating noise templates indicative of vehicle operating faults. The verbal warning may give detailed verbal instructions on how to react to a given failure or an expected failure in the operation of the vehicle. Thus the safety and ease of use of the vehicle may be improved by the synthesized a speech output.

In order to conserve limited computer resources, such as limited memory and processing power, the speech recognition and noise recognition may be processed in parallel. The system may use switches controlled by a separate controller (controller not shown). A first switch, shown to the left of the noise and speech recognition module 5, may be used to selectively input either noise feature parameters obtained by the noise feature extraction means 3 or speech feature parameters obtained by the speech feature extracting means 4 to the noise and speech recognition module 5. The selection of noise feature parameters or speech feature parameters may be made based on the content of the acoustic signals detected by the microphones 1. If no speech signal is present, only operating noise feature vectors need be input to the noise and speech recognizing module 5. Conversely, if speech content is in fact detected, the speech feature vectors are input to the speech and noise recognizing module 5. The subsequent recognition process may be driven according to which type of feature vectors (operating noises or speech) are input to the noise and speech recognizing module 5.

The detected acoustic signals and the generated microphone signals may comprise speech as well as noise information. If a passenger in a vehicle explicitly wants to use the speech recognition capabilities of the system, noise recognition may be suspended, in order to devote the entire computing power of the system to the speech recognition process. On the other hand, during periods when the speech recognition operation is not in use, noise recognition may be performed exclusively.

The controller may control the noise feature extracting module 3 and the speech extraction module 4 such that the noise extraction module 3 extracts at least one set of noise feature parameters, when it is controlling the speech and noise recognition modules to determine the best matching vehicle operating noise template, and the speech extraction module extracts speech feature parameters when it is controlling the speech and noise recognition modules to determine the best matching speech template.

The controller may control the noise and speech recognition module 5 based on the content of the microphone signals. The speech extraction module 4 may determine that the microphone signals do not contain any speech content. In this case no speech analysis is necessary and all of the system resources may be directed toward noise recognition. Speech recognition may be suspended, for example, if the microphone signals do not include speech signals for at least a predetermined period of time. The predetermined time period may be manually set by a user. Alternatively, a user may be allowed to manually choose between noise and speech recognition operations. Reliability and ease of use can thus, be improved.

A push-to-talk button or switch may be provided. When such a button or switch is provided, a driver or passenger may cause the switch to be placed in an “Off” or “Silent-mode” position. This indicates to the system that the driver or passenger is not addressing the system, and speech signals should be ignored, in this case the controller controls the various switches to connect the noise feature extraction module 3 and the operating noise database 7 to the noise and speech recognition module 5 for processing operating noises. When the push-to-talk button or switch is placed in an “On”- or “Speak”-position, the controller controls the switches to connect the speech extraction module 4 and the speech database 6 to the noise and speech recognition modules 5 in order to process speech signals.

Another switch may allow for inputting data from the speech database 6 or the operation noise database 7 to the noise and speech recognition means 5. Again, the switching will depend on whether speech signals or operating noise signals are being processed.

Yet another switch may be provided for directing the output of the noise and speech recognizing modules. This switch may be provided for directing the noise and speech recognition module 5 output between a speech application, such as a telephone 8, or another non-speech related application such as the display device 9 in response to whether or not speech content is detected in the acoustic signals recorded by the microphones 1, or on the position of a “push-to-talk button or switch, or based on some other criteria. Other switch arrangements are also possible.

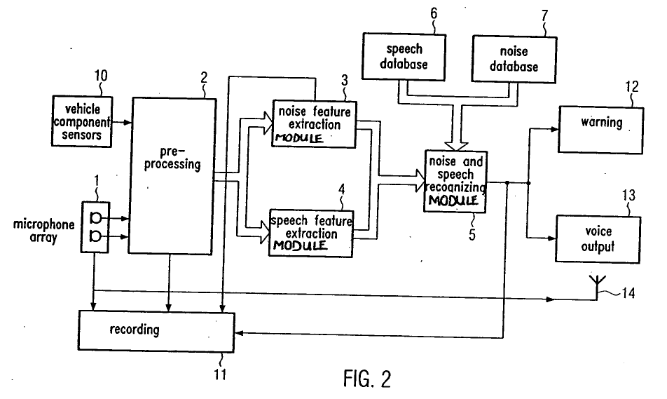

FIG. 2 shows an alternative arrangement for a system for recognizing vehicle operating noises. Again the system includes a microphone array 1, a pre-processor 2, noise and speech feature extraction modules 3 and 4, a noise and speech recognizing module 5, and operating noise and speech databases 6 and 7. The system of FIG. 2 further includes a recording means 11, vehicle component sensors 10, an output warning device 12, a voice output device 13, and a radio transmitting device 14.

Again, the microphone array 1 detects acoustic signals within the vehicle cabin. The microphone array 1 may include multiple microphones, and in fact multiple microphone arrays may be included. The microphone array may include a plurality of directional microphones pointing in different directions. As in the system of FIG. 1, the microphone signals are input to a pre-processor 2. The pre-processor 2 may perform an FFT on the received acoustic signals. Both the unprocessed microphone signals and the pre-processed signals may be stored by the recording means 11.

Additional sensor signals may be obtained by additional vehicle component sensors 10. These additional sensor signals are also input to the pre-processing means 2 and may be stored by the recording means 11. The additional vehicle component sensors 10 may be installed in the vicinity of the engine or within the engine itself or at other locations such as near the transmission, wheel bearings, and the like. The sensor signals obtained by the vehicle component sensors 10, and the microphone signals may be synchronized by the pre-processor 2. The sensor signals 10 may be used by the noise and speech recognizing module 5 to improve performance and reliability of the operating noise recognition process. For example, sensor signals may include information about engine speed. Various operating noise templates stored in the noise database 7 may be associated with specific engine speeds or speed ranges. With this information, the noise and speech recognizing module 5 may first compare templates in the operating noise database 7 associated with the detected engine speed in order to more quickly identify the noise feature vectors extracted from concurrent recorded acoustic signals by the noise feature extraction module 3. Thus, the sensor input may assist the noise and speech recognition module 5 by reducing the set of noise templates that must be evaluated to determine the best match with the extracted operating noise feature parameter. Thus when the speech and operating noise recognition system is provided with signals containing information about the engine speed, or other operating parameters, the reliability of the noise recognition results may be improved. Moreover, the operation of output applications may be influenced by sensor data. For example, an output application may be a device capable of reducing the engine speed in cases of severe faults. When a severe fault is detected the system may be employed to slow the vehicle to a safe speed as indicated by the engine speed sensor.

As in FIG. 1 a noise feature extraction module 3 analyzes the pre-processed microphones signals. The feature parameters obtained by the noise feature extraction means 3 may also be stored by the recording means 11. Thus, the recording means 11 stores signal information from multiple processing stages, this may be helpful in later error analysis.

If the acoustic signals detected by the microphone array 1 contain both operation noise and speech, both the noise feature extraction module 3 and the speech feature extraction module 4 may provide extracted feature parameters to the noise and speech recognizing module 5. The speech recognizing module 5 determines which speech templates stored in the speech database 6 and in the operating noise database 7 best match the noise and speech feature parameters extracted by the noise feature extraction module 3 and the speech feature extraction module 4, respectively. The best matching operating noise template and the best matching speech template may also be stored by the recording means 11.

In the arrangement shown in FIG. 2, after operating noise signals have been processed, analyzed and recognized based on the determined best matching operating noise template, the results may be used to drive various out applications. In this case, three output applications are present. A warning indicator 12, such as a dashboard light or an acoustic warning, such as beeping sounds, or the like, may be activated if some failure or potential failure has been detected. For example, if the best matching operating noise template belongs to a class of templates corresponding to some specific fault, or if the difference between the extracted noise feature parameters and the feature parameters of the closest operating noise template is greater than a predetermined level, again indicating some previously identified operating fault, an appropriate warning mechanism may be activated. Moreover, a voice output 13 may be provided by which the driver can be given specific instructions in case of a failure. Finally, the operating noise recognition system may be equipped with a radio transmitting means 14. In this case, all data stored by the recording means 11 or input to the recording means 11 may also be transmitted to a remote location such as a designated service station, or the like.

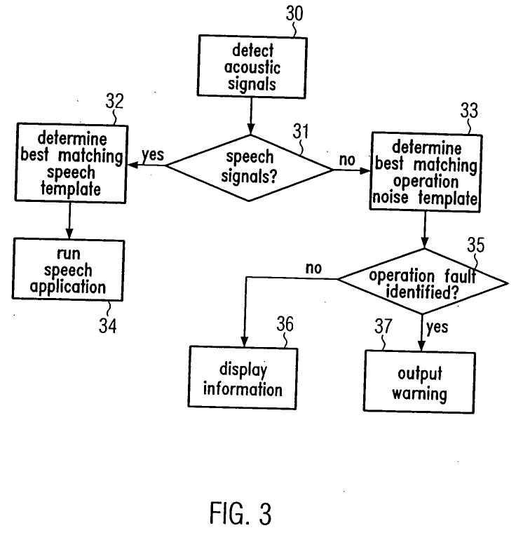

FIG. 3 is a flowchart of a method that recognizes vehicle operating noises. The method includes detecting acoustic signals and determining whether speech signals are present as well as the identification of operating faults. In FIG. 3, acoustic signals are detected at 30 by microphones installed inside a vehicle cabin. A determination is made at 31 whether the detected signals include speech signals. This determination may be carried out during a pre-processing stage of the received signal analysis. In principle, speech signals are easily discriminated from noise signals, using any one of many different methods known to those skilled in the art of noise and/or speech detection.

If speech signals are determined to be present in the received signals at 31, then a best matching speech template is determined at 32 and an appropriate speech application is initiated at 34. If the received acoustic signals only include noise, a best matching operating noise template is determined at 33. Some of the operating noise templates may represent operating noises that indicate some type of failure or fault. Others may represent desired fault free operation. At 35 a determination is made as to whether the operating noise template determined to have been the best match to the received noise signals corresponds to an operating fault or not.

If it is determined that the best matching operating noise template does correspond to an operating fault an output warning is displayed at 37. The warning may comprise acoustic warnings, as beep sounds, and visual warnings displayed on a display device. Otherwise status information is displayed at 36.

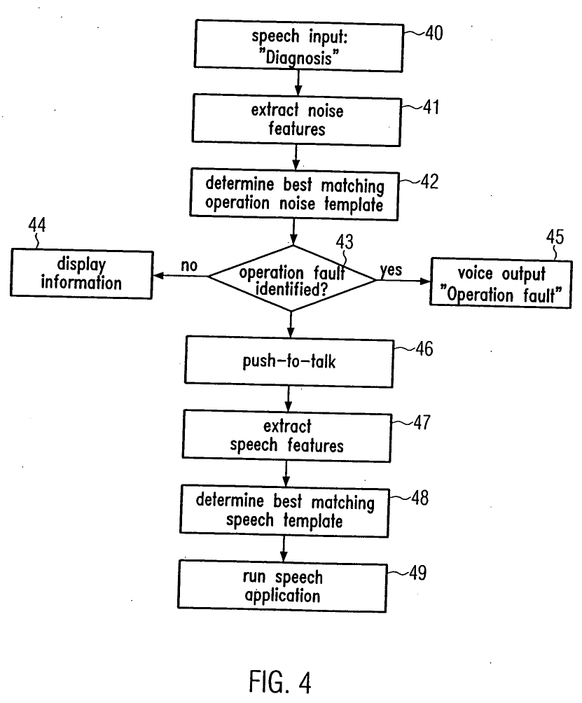

FIG. 4 is a flowchart of another method that recognizes the operating noises of a vehicle. In this method a speech input and a voice output are provided. In FIG. 4, a driver may use speech commands for running an audio diagnosis of the operating state of the vehicle. In this example the driver issues the input command “Diagnosis” at 40. Accordingly, detected audio signals are analyzed to extract noise feature parameters at 41. A best matching operating noise template is determined 42. If a determination is made at 43 whether the best matching template corresponds to an operating fault 43. If so, the speech dialog system may generate voice output prompt such as the warning “Operation fault” at 45. The system may, also the driver may advantageously be provided with further instructions such as, “Stop immediately” or “call emergency service” or the like, in dependence on the kind of the identified operation fault.

At least one set of noise feature parameters may be extracted and at least one operation noise template that best matches the at least one extracted set of noise feature parameters may be determined. If the acoustic signals do not comprise speech signals for at least a predetermined period of time as it may be determined by the feature extracting means that it is suitable to extract sets of noise feature parameters easier than speech feature parameters.

Alternatively, the driver, or another passenger, may wish to switch to the speech recognition mode of operation. In this case, the driver or passenger operates a push-to-talk button or switch at 46 to engage to the speech recognition mode. In this mode the driver or passenger may issue verbal commands to control the operation of various on-board applications such as dialing a hands-free mobile telephone, controlling the vehicle's entertainment system and the like. Accordingly, after the push-to-talk lever has been switched to an “On”-position 46 audio signals are analyzed to extract speech feature parameters 47, and a best matching speech template is determined at 48. Data representations of detected speech signals associated with the best matching speech templates are used to run the particular speech application at 49. In another method at least one set of noise feature parameters is extracted and at least one operating noise template that best matches the at least one extracted set of noise feature parameters is determined, when a push-to-talk lever is pushed in an “off”-position. At least one set of speech feature parameters is extracted and at least one speech template that best matches the at least one extracted set of speech feature parameters is determined when the push-to-talk lever is pushed in an “on”-position.

Moreover, the method may comprise the act of outputting an acoustic and/or visual and/or haptic warning, if differences between the extracted noise feature parameters and the noise feature parameters of the operation noise template determined to best match the at least one extracted set of noise feature parameters exceed a predetermined level, or if the operating noise template determined to best match the at least one extracted set of noise feature parameters is an element of a predetermined set of particular operating noise templates indicative of operating faults.

The method may include transmitting of the best matching operation noise template and/or the at least one extracted set of noise feature parameters and/or the generated microphone signals by a wireless communication device, in particular, to a service station. Transmission may be performed automatically or upon a command entered by a user. If a wireless communication device is provided, the microphone signals may also be automatically transmitted.

The method may include outputting an audio or verbal warning, when the difference between the extracted noise feature parameters and the noise feature parameters of the best matching operating noise template exceeds a predetermined level, or if the best matching operating noise template is an element of a predetermined set of operating noise templates indicative for operation faults. Moreover, the best matching operation noise template and/or the at least one extracted set of noise feature parameters and/or the microphone signals can be stored for a subsequent analysis.

According to the method at least one vehicle component sensor configured to generate sensor signals may be provided. The determining of at best matching least operating noise template may be at least partly based on the sensor signals.

The microphone signals used for the method for recognizing vehicle operating noises a vehicle may be generated by at least one first microphone configured for usage in common speech recognition systems and/or speech dialog systems and/or vehicle hands-free sets. The microphone signals may also be generated by at least one second microphone capable of detecting acoustic signals with frequencies below and/or above the frequency range detected by the at least one first microphone. In particular, the microphone signals can be generated by at least one directional microphone, or through more than one directional microphone pointing in different directions. The microphone signals may be beamformed by an adaptive beamformer. The microphone signals may be beamformed before the at least one set of noise feature parameters and/or the at least one set of speech feature parameters are extracted from the microphone signals. The method may be encoded within a computer program product, comprising one or more computer readable media having computer-executable instructions for performing automatic noise and speech recognition as outlined above.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system for automatic recognition of vehicular noises comprising:
at least one microphone installed within a vehicle cabin, the microphone adapted to detect acoustic signals within the cabin and to generate corresponding microphone signals;
a database comprising speech templates and operating noise templates;
a feature extracting module configured to receive the microphone signals and to extract at least one of a set of operating noise feature parameters and a set of speech feature parameters from the microphone signals; and
a speech and noise recognition module configured to determine one of an operating noise template having operating noise feature parameters, and a speech template having speech feature parameters, that best matches either the extracted set of operating noise feature parameters or the extracted set of speech feature parameters.

2. The system of claim 1 further comprising a controller for controlling the speech and noise recognition module to determine a best matching operating noise template when a set of noise feature parameters has been extracted from the microphone signal, or a best matching speech template when a set of noise feature parameters has been extracted from the microphone signal.

3. The system of claim 1 further comprising a controller for controlling the speech and noise recognition module and the feature extracting module such that the feature extracting module extracts at least one set of operating noise feature parameters when the controller controls the speech and noise recognition module to determine a best matching operating noise template and at least one set of speech feature parameters when the controller controls the speech and noise recognitions module to determine a best matching speech template.

4. The system of claim 1 further comprising a controller for controlling the speech and noise recognition means to determine at least one operation noise template that best matches the at least one extracted set of noise feature parameters when the acoustic signals do not include speech for at least a predetermined time period.

5. The system of claim 1 further comprising a push-to-talk switch, and a controller for controlling the speech and noise recognition module and the feature extracting module, the controller configured to control the speech and noise recognition module to determine at least one operating noise template that best matches at least one extracted set of operating noise feature parameters when the push-to-talk switch is placed in a first position, and at least one speech template that best matches at least one extracted set of speech feature parameters when the push-to-talk switch is placed in a second position.

6. The system of claim 1, further comprising at least one output application configured to perform one or more operations based on at least one determined best matching speech template or at least one determined best matching operating noise template.

7. The system of claim 6, where the at least one output application comprises a warning device configured to output at least one of an acoustic, visual, or haptic warning when the speech and noise recognition module is controlled to determine at least one operating noise template that best matches at least one extracted set of operating noise feature parameters and the difference between one or more extracted noise feature parameters and corresponding operating noise feature parameter associated with the best matching operating noise template exceeds a predetermined level.

8. The system of claim 6, where at least one output application comprises a warning device configured to output at least one of an acoustic, visual, or haptic warning when the speech and noise recognition module is controlled to determine at least one operating noise template that best matches the at least one extracted set of operating noise feature parameters and the determined operation noise template is indicative of an operating fault.

9. System according to one of the claim 6, where the at least one output application comprises a wireless communication device configured to transmit data including at least one of the best matching operating noise template, the at least one extracted set of noise feature parameters and the generated microphone signals.

10. The system of claim 9, where the wireless communication device is configured to automatically transmit data when one of the difference between an extracted operating noise feature parameter and an operating noise feature parameter associated with an operating noise template determined to best match an extracted set of operating noise feature parameters exceeds a predetermined level and the operating noise template determined to best match an extracted set of operating noise feature parameters is indicative of an operating fault.

11. The system of claim 6 where the at least one output application comprises a speech output, configured to output a verbal warning, when one of the difference between one or more extracted operating noise feature parameters and corresponding operating noise feature parameters associated with the best matching operating noise template exceeds a predetermined level, and the operating noise template determined to best match an extracted set of operating noise feature parameters is indicative of an operating fault.

12. The system of claim 1 further comprising at least one vehicle component sensor configured to generate sensor signals, the speech and noise recognition module configured to determine the at least one operating noise template that best matches the at least one extracted set of noise feature parameters partly on the basis of the generated signals.

13. The system of claim 1 comprising a microphone array that include a first microphone adapted for usage in a speech recognition systems, speech dialog systems, or vehicle hands-free sets, and a second microphone capable of detecting acoustic signals with frequencies outside the frequency range detected by the first microphone.

14. The system of claim 13, where the at least one microphone array comprises at least one directional microphone.

15. The system of claim 14, where the at least one microphone array includes a plurality of directional microphones pointing in different directions.

16. The system of claim 13, further comprising an adaptive beamformer configured to obtain beamformed microphone signals.

17. The system of claim 1, further comprising a data recorder for recording the best matching operating noise template, the at least one extracted set of operating noise feature parameter, or the microphone signals.

18. A method for recognizing vehicle operating noise, the method comprising:
providing a speech recognition system that includes a database storing speech templates and operating noise templates;
extracting at least one of a set of operating noise feature parameters and a set of speech feature parameters from microphone signals generated from acoustic signals by at least one microphone installed in a vehicle cabin; and
determining one of an operating noise template that best matches the at least one extracted set of operating noise feature parameters and a speech template that best matches the at least one extracted set of speech feature parameters.

19. The method of claim 18, where at least one set of operating noise feature parameters is extracted and at least one operating noise template that best matches the at least one extracted set of operating noise feature parameters is determined when the acoustic signals do not include speech for at a predetermined period of time.

20. The method of claim 18, further comprising providing a switch, where at least one set of operating noise feature parameters is extracted and at least one operating noise template that best matches the at least one extracted set of operating noise feature parameters is determined when the switch is placed in a first position, and at least one set of speech feature parameters is extracted and at least one speech template that best matches the at least one extracted set of speech feature parameters is determined when the switch is placed in a second position.

21. The method of claim 18, in further comprising providing an output warning when the difference between the extracted operating noise feature parameters and the noise feature parameters associated with the operating noise template determined to best match the at least one extracted set of operating noise feature parameters exceeds a predetermined level.

22. The method of claim 18 further comprising providing an output warning when the operating noise template determined to best match the at least one extracted set of operating noise feature parameters is indicative of an operating fault.

23. The method of claim 18 further comprising transmitting via a wireless communication device at least one of the best matching operating noise template, the at least one extracted set of operating noise feature parameters and the generated microphone signals.

25. The method of claim 23, whereat least one of the best matching operating noise template, the at least one extracted set of operating noise feature parameter, and the generated microphone signals are automatically transmitted when the difference between at least one extracted operating noise feature parameters and operating noise feature parameters associated with the operating noise template determined to best match the at least one extracted set of operating noise feature parameters exceeds a predetermined level.

26. The method of claim 23 where at least one of the best matching operating noise template, the at least one extracted set of operating noise feature parameters; and the generated microphone signals are automatically transmitted when the operating noise template determined to best match the at least one extracted set of operating noise feature parameters indicative of an operating fault.

27. The method of claim 18, further comprising generating a verbal warning when the difference between the an extracted operating noise feature parameters and an operating noise feature parameter associated with the operating noise template determined to best match the at least one extracted set of operating noise feature parameters exceeds a predetermined level.

28. The method of claim 18 further comprising generating a verbal warning when the operating noise template determined to best match the at least one extracted set of operating noise feature parameters is indicative of an operating fault.

29. The method of claim 18, further comprising storing at least one of the best matching operating noise template, the at least one extracted set of operating noise feature parameters and the microphone signals.

30. The method of claim 18, further comprising providing at least one vehicle component sensor configured to generate sensor signals, where operating noise template best matching the at least one extracted set of operating noise feature parameters is determined partly based on the sensor signals.

31. The method of claim 18 further comprising providing a microphone array for generating the microphone signals, the microphone array including a first microphone adapted for use in at least one of a speech recognition systems, a speech dialog system and a vehicle hands-free set, and a second microphone capable of detecting acoustic signals with frequencies outside the frequency range detected by the first microphone.

32. The method of claim 18, further comprising providing a microphone array for generating the microphone array including at least are one directional microphone.

33. The method of claim 32, where the microphone array includes a plurality of directional microphones pointing in different directions.

34. The method claim 32, further comprising providing an adaptive beamformer for beamforming the microphone signals before the at least one of a set of noise feature parameters and a set of speech feature parameters are extracted from the microphone signals.

35. A computer readable medium having computer-executable instructions stored thereon for providing a speech recognition system that includes a database storing speech templates and operating noise templates; extracting at least one of a set of operating noise feature parameters and a set of speech feature parameters from microphone signals generated from acoustic signals by at least one microphone installed in a vehicle cabin; and determining one of an operating noise template that best matches the at least one extracted set of operating noise feature parameters and a speech template that best matches the at least one extracted set of speech feature parameters.
